(19) United States
(12) Patent Application Publication
(10) Pub. No.: US 2024/0211830 A1
(43) Pub. Date: Jun. 27, 2024

(54) SYSTEM AND METHOD FOR MANAGING ISSUES BASED ON COGNITIVE LOADS

(71) Applicant: Dell Products L.P., Round Rock, TX (US)

(72) Inventors: ANNE-MARIE MCREYNOLDS, San Jose, CA (US); MING QIAN, Allston, MA (US); CHRISTOPHER O'BRYON HILL, Bellevue, WA (US); VINAY SAWAL, Fremont, CA (US)

(21) Appl. No.: 18/145,075

(22) Filed: Dec. 22, 2022

(51) Int. Cl. G06Q 10/0631; G06Q 10/10

(52) U.S. Cl. CPC G06Q 10/063112; G06Q 10/103

(57) ABSTRACT

Methods and systems for managing customer-encountered issues are disclosed. To manage the customer-encountered issues, cognitive loads likely to be imposed on service agents for resolving the customer-encountered issues may be estimated. The cognitive load estimates may be used to identify service agents likely to be able to shoulder the cognitive loads for resolving the customer-encountered issues thereby reducing the likelihood of occurrence of resolution attempt failures. Consequently, the average time to resolve customer-encountered issues may be reduced through reduced likelihood of escalation of the customer-encountered issues.

### FIELD

Embodiments disclosed herein relate generally to issue management. More particularly, embodiments disclosed herein relate to systems and methods to manage issues through skill matching.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show diagrams illustrating data flows, processes, and other aspects of a system in accordance with an embodiment.

FIG. 3A shows a flow diagram illustrating a method of resolving customer-encountered issues in accordance with an embodiment.

FIG. 3B shows a flow diagram illustrating a method of identifying cognitive loads for resolving customer-encountered issues in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing customer-encountered issues. To manage the customer-encountered issues, service requests for the customer-encountered issues may be serviced by service agents. However, the number of service agents may be limited thereby limiting the customer-encountered issues that may be serviced per unit time. Additionally, in the event that a service agent is assigned to resolve a service request but fails, the service request may be escalated and assigned to another service agent to resolve thereby further reducing the rate of resolution and increasing time to resolution.

To improve the rate of resolving customer-encountered issues and reduce the time to resolution, the service requests may be rated based on a cognitive load that will likely be imposed on a service agent for resolving the issues. The cognitive load may be estimated based on the intrinsic, extraneous, and germane cognitive loads presented by the customer-encountered issues upon which the service requests are based. The cognitive load estimates for the service requests may establish a hierarchy through which the service requests are viewed.

Likewise, the service agents may be placed in a hierarchy based on factors such as knowledge, experience, etc. that may indicate their relatively ability to shoulder different levels of cognitive load. When a new service request is obtained, the estimated cognitive load may be used to select one of the service agents to work the service request. The selected service agent may be selected in a manner that improves that likelihood that the service agent will be able to shoulder the cognitive load for resolving the service request, thereby improving the likelihood of successful resolution, reducing time to remediation and likelihood of escalation.

Thus, embodiments disclosed herein may address the technical problem of resource limitations in response management systems. Due to limited availability of resources, only certain numbers and types of remediation processes may be implemented per unit time. By reducing the time to resolution through improved service agent assignment based on cognitive load, the limited quantity of resources may be able to resolve more customer-encountered issues per unit time through avoidance of resolution failures and escalation.

In an embodiment, a method for managing customer-encountered issues using service agents is disclosed. The method may include estimating a cognitive load to resolve a customer-encountered issue of the customer-encountered issues; selecting a service agent level based on the cognitive load; selecting a service agent of the service agents, the selected service agent having the selected service agent level; and resolving the customer-encountered issue by assigning the selected service agent to work the customer-encountered issue.

Estimating the cognitive load may include calculating a first metric based on a level of complexity for resolving the customer-encountered issue; calculating a second metric based on a level of difficulty in processing information regarding the customer-encountered issue; calculating a third metric based on a ratio of available information related to the customer-encountered issue to available information usable to resolve the customer-encountered issue; and calculating a numerical score based on the first metric, the second metric, and the third metric, the numerical score representing the estimate of the cognitive load.

The numerical score may be calculated using a weight sum of the first metric, the second metric, and the third metric.

Calculating the first metric may include making a first determination regarding whether the customer-encountered issue is a known issue; and, in a first instance of the first determination where the customer-encountered issue is known, retaining the first metric at a current score.

Calculating the first metric may also include, in a second instance of the determination where the customer-encountered issue is not known: making a second determination regarding whether a run book for a class of the customer-encountered issue is available; in a first instance of the second determination where the run book for the class of the customer-encountered issue is available, increasing the current score of the first metric by a first amount; in a second instance of the determination where no run book for the class of the customer-encountered issue is available, increasing the current score of the first metric by a second amount, the second amount being larger than the first amount.

Calculating the second metric may include identifying available support data for the customer-encountered issue; making a first determination regarding whether the available support data is complete; in a first instance of the first determination where the available support data is complete, retaining the second metric at a current score; in a second instance of the first determination where the available support data is incomplete, increasing the current score of the second metric.

Increasing the current score of the second metric may include enumerating the support data based on a schema that defines expected portions of data for the support data to be complete; calculating a numerical value based on a number of elements of the schema that are not present in the enumerated support data; and adding a value to the current score based on the numerical value.

The estimate of the cognitive load may be based on an inherent cognitive load, an extraneous cognitive load, and a germane cognitive load.

The estimate of the cognitive load may fall within a range of available service agent levels.

A non-transitory media may include instructions that when executed by a processor cause the computer-implemented method to be performed.

A data processing system may include the non-transitory media and a processor, and may perform the computer-implemented method when the computer instructions are executed by the processor.

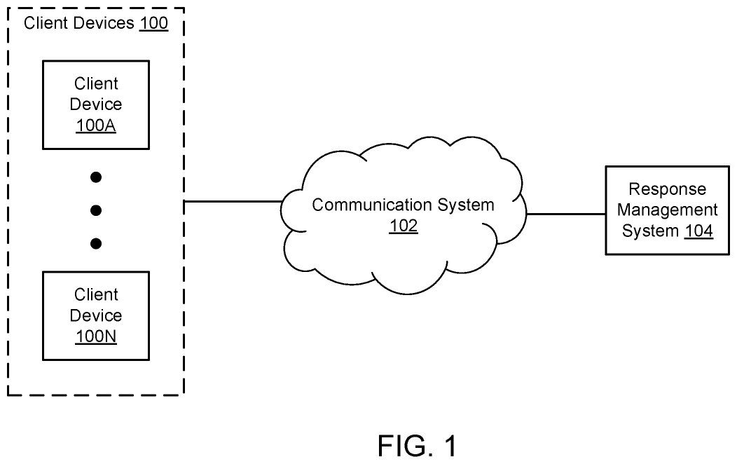

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer-implemented services, the system may include any number of client devices 100. Client devices 100 may provide the computer implemented services to users of client devices 100 and/or to other devices (not shown). Different client devices (e.g., 100A, 100N) may provide similar and/or different computer implemented services.

To provide the computer-implemented services, client devices 100 may include various hardware components (e.g., processors, memory modules, storage devices, etc.) and host various software components (e.g., operating systems, application, startup managers such as basic input-output systems, etc.). These hardware and software components may provide the computer-implemented services via their operation.

To provide certain computer-implemented services, the hardware and/or software components of client devices 100 may need to operate in predetermined manners. If the hardware and/or software components do not operate in the predetermined manners, then a client device may be unable to provide all, or a portion, of the computer-implemented services that it normally provides (and may be expected by the users of the client device to reliably provide).

The hardware and/or software components of client devices 100 may operate differently (e.g., in an undesirable manner) from the predetermined manners for any number of reasons. For example, any of the hardware and/or software components may malfunction. In another example, the hardware and/or software components may be operating nominally but in undesirable manners through various interactions such as resource conflicts or constraints. In a further example, various configuration settings of the hardware and/or software components may be set (intentionally or inadvertently) in a manner that causes the operation of any of client devices 100 to be undesirable. The hardware and/or software components of client devices 100 may operate different from the predetermined manners for other reasons (e.g., various root causes) without departing from embodiments disclosed herein. Thus, a client device may not provide its computer-implemented services for any number of reasons which may be difficult to identify.

The undesired operation of client devices 100 may take any number of forms which may be linked to a root cause of the undesired operation. For example, an undesired operation of a client device may be a lack of operation such as failing to power on when a power button is depressed. In another example, an undesired operation of a client device may be a failure of the client device to utilize a full width of a display when presenting information to a user via the display. In a further example, an undesired operation of a client device may be inconsistent operation of the client device over time such as the client device intermittently freezing for periods of time during which the client device is unresponsive to a user and/or other devices. The undesired operation of client devices 100 may manifest in other manners without departing from embodiments disclosed herein. Thus, a client device may manifest any number of undesired operations which may be due to any number of root causes.

To improve the likelihood of client devices 100 providing desired computer implemented services, the system of FIG. 1 may include response management system (RMS) 104. RMS 104 may be tasked with addressing undesired operation of any of client devices 100. However, RMS 104 may have limited resources with which to address the undesired operation of client devices 100.

In general, embodiments disclosed herein may provide methods, systems, and/or devices for managing undesired operation of client devices 100. To manage the undesired operation (e.g., also referred to as a “client encountered issue”) of client devices 100, RMS 104 may provide remediation services to address the undesired operation of client devices 100. The remediation services may include diagnosing, managing, and otherwise resolving the undesired operation.

To provide the remediation services, service agents (e.g., trained persons) may be assigned to address the undesired operation of client devices 100. The service agents may have different levels of skills and/or knowledge with respect to how to resolve undesired operation of client devices 100.

For example, some of the service agents may have more knowledge and/or experience resolving undesired operation of client devices 100. The knowledge and skill may allow more experience service agents to more address undesired operation of client devices 100 that may be, for example, more challenging to diagnose an underlying root cause. However, because not all service agents may have similar levels of knowledge and experience, the service agents may be placed into a hierarchy where the positions in the hierarchy are based on the levels of knowledge and experience of the service agents. Generally, the more knowledgeable and experienced service agents may be placed higher in the hierarchy while less knowledgeable or experienced service agents may be placed lower in the hierarchy.

To manage resolution of undesired operation of client devices 100, the system may direct service agents at various levels in the hierarchy to attempt to remediate the undesired operation of client devices 100. The system may do so by directing service agents higher in the hierarchy to address more challenging undesired operation of client device 100 and service agents lower in the hierarchy to address less challenging undesired operation.

When new client encountered issues are identified, the system may classify the customer-encountered issues and assign service agents to remediate the customer-encountered issues based on the classifications. The classifications may be based on an estimated cognitive load believed to be placed on a service agent that is assigned to remediate the customer-encountered issues.

The cognitive load estimates may take into account inherent cognitive load (e.g., task complexity), extraneous cognitive load (e.g., difficulty of processing information to resolve the issue due to factors that are extraneous to the issue), and germane cognitive load (e.g., the amount of information that may need to be sifted through to identify how to resolve an issue). The cognitive load estimates may be numerical rankings based on quantifiable information, and may be used to assign service agents of varying levels to address different customer-encountered issues.

By doing so, customer-encountered issues that are rated as exerting a higher cognitive load for remediation may be initially assigned to service agents that are higher in the hierarchy. Consequently, these customer-encountered issues may not be worked on by service agents that are lower in the hierarchy and that may have a low likelihood of resolving the customer-encountered issues. Accordingly, the customer-encountered issues may be remediated more quickly on average by avoiding (i) failed attempts at resolution by lower ranked service agents, (ii) delays in escalation of failed attempts at resolution to higher ranked service agents, and/or (iii) other delays in resolution of customer-encountered issues due to initial assignment of customer-encountered issues to service agents that are unlikely to be able to resolve the issues.

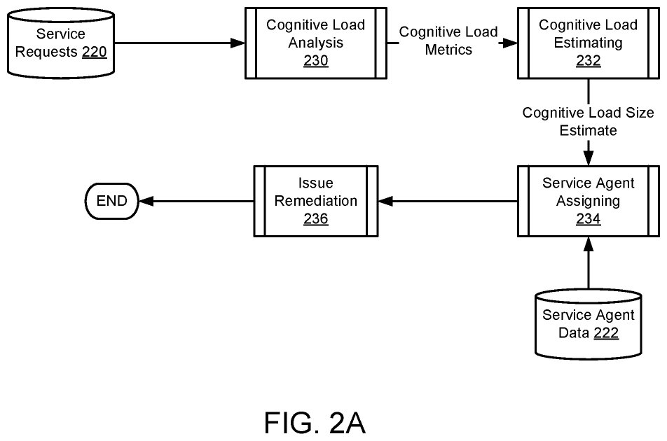

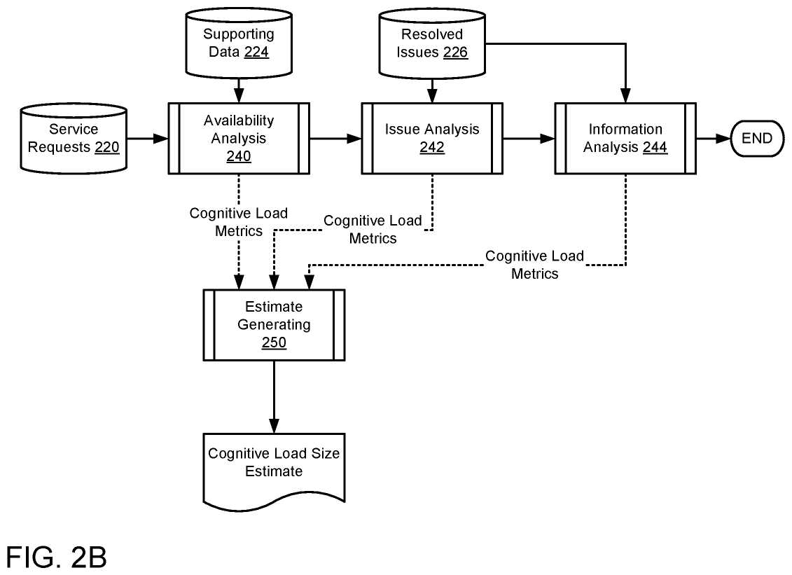

To provide the remediation services, RMS 104 may (i) receive information (e.g., telemetry data such as error alerts, logs that indicate operation of a client device, etc.) from users of client devices 100 regarding various customer-encountered issues (e.g., undesired operation of client devices 100 encountered by users thereof) with respect to client devices 100, (ii) establish service requests (or other artifacts to track remediation) based on the customer-encountered issues (the service requests may be tracked using a ticketing system), (iii) obtaining cognitive load estimates for the service request, and/or (iv) assigning service agents at different levels within a hierarchy to resolve the customer-encountered issues based on the cognitive load estimates (e.g., customer-encountered issues having higher cognitive load estimates may be assigned to service agents higher in the hierarchy). Refer to FIGS. 2A-B for additional details regarding obtaining cognitive load estimates and using the cognitive load estimates to remediate customer-encountered issues.

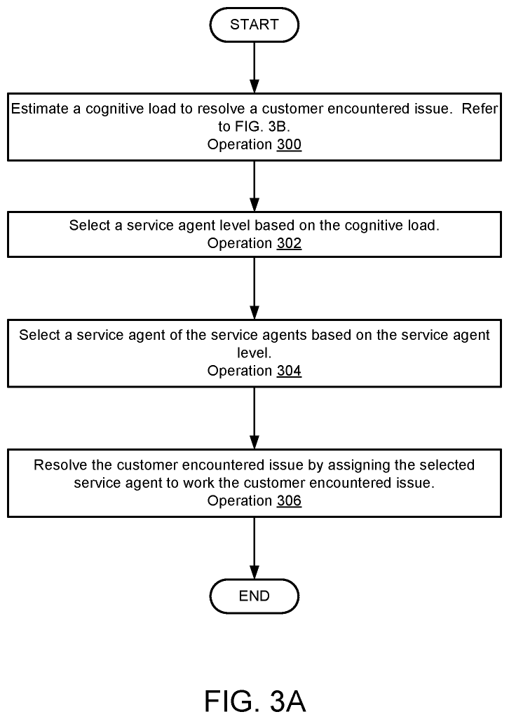

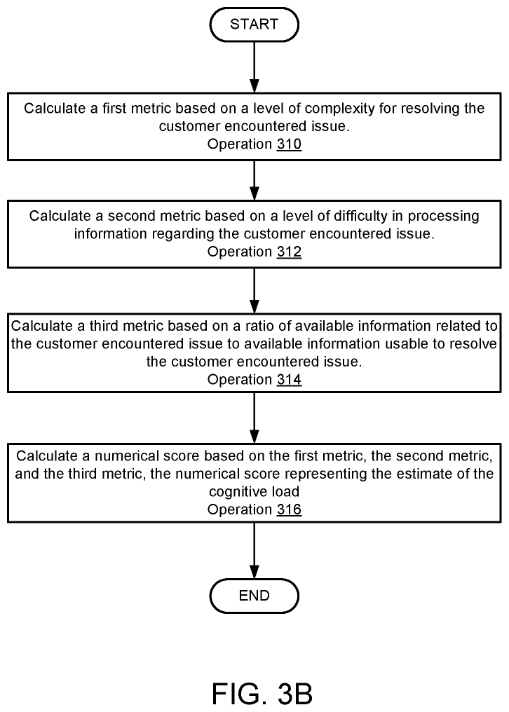

When providing its functionality, RMS 104 may perform all, or a portion, of the methods illustrated in FIGS. 3A-3B.

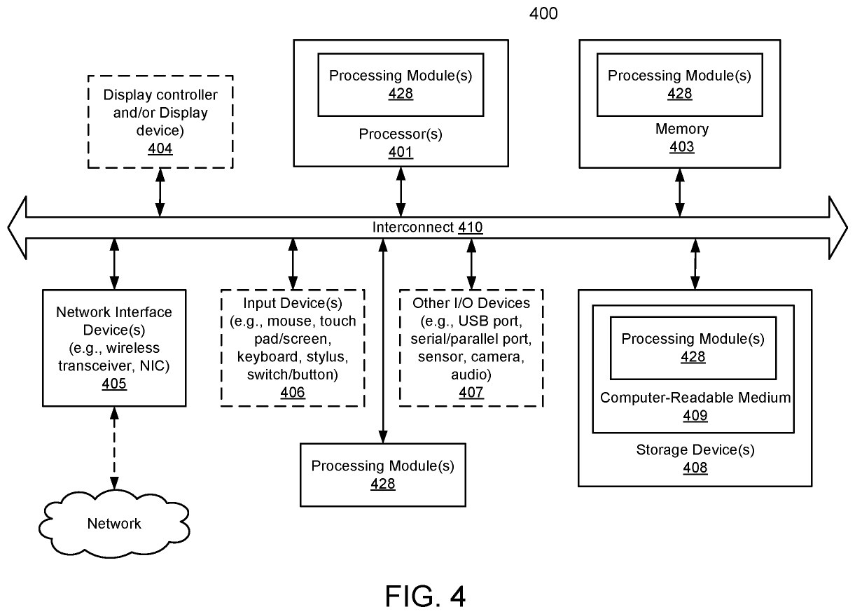

Any of client devices 100 and/or RMS 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

RMS 104 may be implemented with multiple computing devices. The computing devices of RMS 104 may cooperatively perform processes for managing customer-encountered issues. The computing devices of RMS 104 may perform similar and/or different functions, and may be used by different persons that may participate in the management of the customer-encountered issues. For example, RMS 104 may include multiple computing devices used by different service agents (e.g., persons) tasked with resolving customer-encountered issues. The service agents may attempt to utilize knowledge base articles to resolve the customer-encountered issues.

RMS 104 may be maintained, for example, by a business or other entity that has some degree of responsibility with respect to maintaining the operation of client devices 100. For example, RMS 104 may be operated by a business that sells client devices 100 and provides warranty or other types of support for client devices 100 to users and/or owners thereof.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as included a limited number of specific components, a system in accordance with an embodiment may include fewer, additional, and/or different components than those illustrated therein.

To further clarify embodiments disclosed herein, diagrams illustrating data flows implemented by and data structures used by a system over time in accordance with an embodiment are shown in FIGS. 2A-2B. In FIGS. 2A-2B, data structures are represented using a first set of shapes (e.g., 220-226) and processes are represented using a different set of shapes (e.g., 230-250).

Turning to FIG. 2A, a data flow diagram illustrating data flows, data processing, and/or other operations that may be performed by RMS 104 in accordance with an embodiment is shown.

To manage customer-encountered issues, RMS 104 may obtain service requests 220. Service requests 220 may be data structures that include information regarding the customer-encountered issues. Service requests 220 may be obtained by (i) obtaining information regarding the customer-encountered issues and (ii) adding the obtained information to a new or existing data structure representing a service request. The information may be obtained, for example, by (i) receiving the information via a portal (e.g., a website), (ii) receiving the information via phone calls, video calls, instant messages, and/or via other types of interactions with users (which may be subsequently subjected to processing to derive recordable information regarding the user and the customer encounter issue), and/or (iii) via other methods.

After being obtained, service requests 220 may be subjected to cognitive load analysis 230 to identify cognitive load metrics for each service request. The cognitive load metrics may represent the different types of cognitive load (e.g., intrinsic, extraneous, etc.) that may be placed on a service agent tasked with serving the service requests. The cognitive load metrics may be numerical values representing the magnitude of the load imposed by the corresponding type of cognitive load.

The cognitive load estimates for each service request may be used to drive cognitive load estimating 232. During cognitive load estimating 232, a cognitive load size estimate for each service may be obtained. The cognitive load size estimate for a service request may be based on the cognitive load metrics for that service request. Refer to FIG. 2B for additional details regarding cognitive load metrics and cognitive load size estimates.

The cognitive load size estimates may be used to drive service agent assigning 234. During service agent assigning 234, the cognitive load size estimates for the service requests may be used to select a service agent to remediate the service request. As discussed above, the service agents may be divided into a hierarchy based on the knowledge and experience levels. For example, each of the service agents may be given a numerical ranking that defines their place within the hierarchy. These numerical rankings may be stored in service agent data 222.

The cognitive load size estimate may be a numerical value on a scale that matches the numerical rankings assigned to the service agent. To assign a service agent to resolve a service request, the value of the cognitive load estimate for the customer-encountered issue associated with a service request may be used to identify one or more of the service agents (e.g., through matching and/or matching within a range based on the numerical rankings of the service agents). Then, one of the identified service agents (e.g., having both availability and most similar ranking to the cognitive load size estimate, and/or at least higher than the cognitive load size estimate) may be assigned to resolve the customer-encountered issue.

The assigned service agent may then, as part of issue remediation 236, work to resolve the customer-encountered issue until resolve or elevated after failure to resolve the issue.

Thus, by implementing the flow shown in FIG. 2A, a system in accordance with embodiments disclosed herein may be more likely to assign service agents that have sufficient knowledge and experience to resolve customer-encountered issues. By doing so, failed attempts to resolve customer-encountered issues may be reduced thereby reducing the average time to resolve customer-encountered issues and service agent burnout.

Turning to FIG. 2B, a data flow diagram illustrating data flows, data processing, and/or other operations that may be performed by RMS 104 in accordance with an embodiment is shown. The processes illustrated in FIG. 2B may be used to obtain cognitive load size estimates. FIG. 2B may be an expansion of cognitive load analysis 230 and cognitive load estimating 232 shown in FIG. 2A.

When a service request (e.g., 220) is received, multiple analyses may be initiated to identify cognitive load metrics that represent different types of cognitive loads that may be imparted to the service of the service request. These analyses may include availability analysis 240, issue analysis 242, and information analysis 244. These analyses may form a pipeline, with different analysis being performed sequentially and/or in parallel with other analysis. Each of the analyses is discussed below.

Availability analysis 240 may identify an extrinsic cognitive load, and may include (i) identifying whether information necessary to resolve the issues is available, and (ii) when some information is not available, the extent of the unavailability. The level of extrinsic cognitive load may be based on the extent of the unavailability of the information likely to be necessary to resolve the service request.

For example, when a service request is obtained, various types of data (e.g., logs, telemetry data, error messages, etc.) may be collected and stored in supporting data 224. To resolve the service request, any of these data structures may include information relevant to resolving the service request. However, due to technical challenges or other issues, some of these data structures typically collected may not be available.

The content of supporting data 224 may be compared to a schema, rubric, or other standard that indicates the data structures (and/or information included therein) that should be available to resolve the service request. If at least some of the data structures indicated by the standard are not available, then the extent of the unavailability may be identified through enumeration and quantification of the unavailable data structures. A numerical value based on the ratio of available data structures to the total data structures specified by the standard may be calculated (e.g., a value in the range of 0 to 1) and used as the extrinsic load (which may be used as one of the cognitive load metrics to drive estimate generating 250, discussed below).

Issue analysis 242 may identify an intrinsic cognitive load, and may include (i) identifying whether the customer-encountered issue upon which a service request is based is a known issue, and (ii) if an unknown issue, whether the type of issue has an associated plan or set of actions available to attempt a remediation. The plan or set of actions may be implemented with a runbook, script, or other type of semi-automated process that may be performed to attempt to resolve a type of the customer-encountered issue.

The customer-encountered issue may be compared to information included in resolved issues 226 to identify whether the issue is known (e.g., through searching and identifying knowledge base articles or other information that documents the issue and/or resolution procedures). Similarly, the type of the customer-encountered issue may be compared to resolved issues 226 to identify if any standardized approaches to attempting resolutions for the issue type are available.

A numerical value based on whether the customer-encountered issue is known and/or, for unknown issues, whether a standardized approach (e.g., a runbook) for attempt to resolve the type of the unknown issue is available. For example, if the issue is known, then a value of 0 for the intrinsic load may be ascribed to the customer-encountered issue. However, if the issue is unknown but a standardized approach for the type of the unknown issue is available, then a value of 0.5 for the intrinsic cognitive may be assigned. A value of 1 for the intrinsic cognitive load may be assigned if the issue is both unknown and no standardized resolution process of the type of unknown issue is available.

Information analysis 244 may identify a germane cognitive load, and may include (i) identifying the quantity of information related to the issue that is available, and (ii) the ratio of that information that is relevant to resolving the issue to the ratio that is merely descriptive for the issue. For example, information analysis 244 may include reviewing the ratio of articles, guides, and other information from resolved issues 226 and/or other sources with respect to its relevancy for resolving an issue versus identifying or describing the issue.

A numerical value based on the ratio of information describing resolution procedures versus identification or other procedures may be used as the germane cognitive load.

However, the germane cognitive load may be identified via other methods. For example, the germane cognitive load may be calculated based on the intrinsic and extraneous cognitive loads (e.g., an addition of the two loads, or some other combination).

During performance of the analyses pipeline, cognitive metrics may be obtained and used as part of estimate generating 250 to obtain the cognitive load size estimate. Estimate generating may including ingesting the cognitive load metrics into a function that outputs the cognitive load size estimate. The function may include a weighted sum of the respective cognitive load metrics. For example, the function may have the form of f(x, y, z)=a*x+b*y+c*z, where x, y, and z are the respective intrinsic, extraneous, and germane cognitive load values and a, b, an c are constants. The constants may be selected to weight each the cognitive loads in the sum.

Thus, via the processes illustrated in FIG. 2B, a system in accordance with an embodiment may automatically identify cognitive loads likely to be imposed on service agents assigned to work various service requests.

In an embodiment, RMS 104 is implemented using a hardware device including circuitry. The hardware device may be, for example, a digital signal processor, a field programmable gate array, or an application specific integrated circuit. The circuitry may be adapted to cause the hardware device to perform the functionality of RMS 104 such as cognitive load analysis 230, cognitive load estimating 232, service agent assigning 234, issue remediation 236, availability analysis 240, issue analysis 242, information analysis 244, estimate generating 250, and/or other processes. RMS 104 may be implemented using other types of hardware devices without departing embodiment disclosed herein.

In one embodiment, RMS 104 is implemented using a processor adapted to execute computing code stored on a persistent storage that when executed by the processor performs the functionality of RMS 104 discussed throughout this application such as cognitive load analysis 230, cognitive load estimating 232, service agent assigning 234, issue remediation 236, availability analysis 240, issue analysis 242, information analysis 244, estimate generating 250, and/or other processes. The processor may be a hardware processor including circuitry such as, for example, a central processing unit, a processing core, or a microcontroller. The processor may be other types of hardware devices for processing information without departing embodiment disclosed herein.

In an embodiment, RMS 104 includes storage which may be implemented using physical devices that provide data storage services (e.g., storing data and providing copies of previously stored data). The devices that provide data storage services may include hardware devices and/or logical devices. For example, storage may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage may include a memory device (e.g., a dual in line memory device) in which data is stored and from which copies of previously stored data are provided. In another example, storage may include a persistent storage device (e.g., a solid-state disk drive) in which data is stored and from which copies of previously stored data is provided. In a still further example, storage may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

Storage may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage may store data structures including service requests 202, service agent data 222, supporting data 224, resolved issues 226, and/or other data structures. Any of these data structures may be implemented using, for example, lists, tables databases, linked lists, unstructured data, and/or other types of data structures.

As discussed above, the components of FIG. 1 may perform various methods to manage customer-encountered issues. FIGS. 3A-3B illustrate methods that may be performed by the components of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of resolving customer-encountered issues in accordance with an embodiment is shown. The method may be performed by RMS 104 or other components of the system shown in FIG. 1.

At operation 300, a cognitive load to resolve a customer-encountered issue is obtained. The cognitive load may be obtained by analyzing a service request for the customer-encountered issue, information associated with the customer-encountered issue, and/or via other information to identify an intrinsic cognitive load, an extraneous cognitive load, and a germane cognitive load like to be placed on a service agent tasked with resolving the service request. These cognitive loads may be used to identify an aggregate cognitive load through a weighted sum (or other function) of these cognitive loads. The resulting cognitive load may be implemented using a numerical value that falls within a rank of rankings ascribed to service agents (e.g., level one through level 3).

In an embodiment, the cognitive load is obtained via the method illustrated in FIG. 3B. The cognitive load may be obtained via other methods without departing from embodiments disclosed herein.

At operation 302, a service agent level is selected based on the cognitive load. The service agent level may be selected by (i) rounding the cognitive load value to a nearest integer (e.g., rounding 1.4 to 1 and 1.6 to 2), (ii) rounding the cognitive load value to the next largest integer (e.g., rounder 1.4 to 2), and/or (iii) otherwise using a functional relationship between the cognitive load and a service agent level to select the service agent level.

At operation 304, a service agent of the service agents is selected based on the service agent level. The service agent may be selected by (i) identifying the service agents ranked at the selected service agent level, and (ii) selecting one of the identified service agents. The service agent of the identified service agents may be selected based on, for example, the availability of the service agent (e.g., when compared to the availability of other service agents), a work schedule of the service agent, and/or other factors.

At operation 306, the customer-encountered issue is resolved by assigning the selected service agent to work the customer-encountered issue. The service agent may be assigned by, for example, populating a workflow management system or other system with information indicating that the assigned service agent is responsible for resolving the customer-encountered issue.

The method may end following operation 306.

Using the method illustrated in FIG. 3A, a system in accordance with an embodiment may assign service requests to service agents that are more likely to have knowledge and experience likely to be necessary to resolve the service requests, thereby reducing escalation which may delay resolution of the service requests.

Turning to FIG. 3B, a flow diagram illustrating a method of identifying cognitive loads for resolving customer-encountered issues in accordance with an embodiment is shown. The method may be performed by RMS 104 or other components of the system shown in FIG. 1.

At operation 310, a first metric based on a level of complexity for resolving the customer-encountered issue is calculated. The first metric may be an intrinsic cognitive load for resolving the customer-encountered issue. The first metric may be a numerical value, and may be calculated as described with respect to FIG. 2B.

At operation 312, a second metric based on a level of difficulty in processing information regarding the customer-encountered issue is calculated. The second metric may be an extraneous cognitive load for resolving the customer-encountered issue. The second metric may be a numerical value, and may be calculated as described with respect to FIG. 2B.

At operation 314, a third metric based on a ratio of available information related to the customer-encountered issue to available information usable to resolve the customer-encountered issue is calculated. The third metric may be a germane cognitive load for resolving the customer-encountered issue. The third metric may be a numerical value, and may be calculated as described with respect to FIG. 2B.

At operation 316, a numerical score is calculated based on the first metric, the second metric, and the third metric. The numerical score may represent the estimate of the cognitive load. The numerical score may be calculated using a function (e.g., a weighted sum) that ingest the three metrics and outputs the cognitive load.

The method may end following operation 316.

Thus, using the methods illustrated in FIGS. 3A-3B, embodiments disclosed herein may expedite resolution of customer-encountered issues by aligning cognitive load for resolving customer-encountered issues with service agents with knowledge and experience likely necessary to resolve the customer-encountered issues thereby reducing likelihood of resolution failures and issue escalation (which may both increase the time to resolve the customer-encountered issues).

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac Os®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing customer-encountered issues using service agents, the method comprising:
estimating a cognitive load to resolve a customer-encountered issue of the customer-encountered issues;
selecting a service agent level based on the cognitive load;
selecting a service agent of the service agents, the selected service agent having the selected service agent level; and
resolving the customer-encountered issue by assigning the selected service agent to work the customer-encountered issue.

2. The method of claim 1, wherein estimating the cognitive load comprises:
calculating a first metric based on a level of complexity for resolving the customer-encountered issue;
calculating a second metric based on a level of difficulty in processing information regarding the customer-encountered issue;
calculating a third metric based on a ratio of available information related to the customer-encountered issue to available information usable to resolve the customer-encountered issue; and
calculating a numerical score based on the first metric, the second metric, and the third metric, the numerical score representing the estimate of the cognitive load.

3. The method of claim 2, wherein the numerical score is calculated using a weight sum of the first metric, the second metric, and the third metric.

4. The method of claim 2, wherein calculating the first metric comprises:
making a first determination regarding whether the customer-encountered issue is a known issue; and
in a first instance of the first determination where the customer-encountered issue is known, retaining the first metric at a current score.

5. The method of claim 4, wherein calculating the first metric further comprises:
in a second instance of the determination where the customer-encountered issue is not known:
making a second determination regarding whether a run book for a class of the customer-encountered issue is available;
in a first instance of the second determination where the run book for the class of the customer-encountered issue is available, increasing the current score of the first metric by a first amount;
in a second instance of the determination where no run book for the class of the customer-encountered issue is available, increasing the current score of the first metric by a second amount, the second amount being larger than the first amount.

6. The method of claim 2, wherein calculating the second metric comprises:
identifying available support data for the customer-encountered issue;
making a first determination regarding whether the available support data is complete;
in a first instance of the first determination where the available support data is complete, retaining the second metric at a current score;
in a second instance of the first determination where the available support data is incomplete, increasing the current score of the second metric.

7. The method of claim 6, wherein increasing the current score of the second metric comprises:
enumerating the support data based on a schema that defines expected portions of data for the support data to be complete;
calculating a numerical value based on a number of elements of the schema that are not present in the enumerated support data; and
adding a value to the current score based on the numerical value.

8. The method of claim 1, wherein the estimate of the cognitive load is based on an inherent cognitive load, an extraneous cognitive load, and a germane cognitive load.

9. The method of claim 8, wherein the estimate of the cognitive load falls within a range of available service agent levels.

10. A non-transitory machine-readable medium having instructions stored therein, which when executed by a processor, cause the processor to perform operations for managing customer-encountered issues using service agents, the operations comprising:
estimating a cognitive load to resolve a customer-encountered issue of the customer-encountered issues;
selecting a service agent level based on the cognitive load;
selecting a service agent of the service agents, the selected service agent having the selected service agent level; and
resolving the customer-encountered issue by assigning the selected service agent to work the customer-encountered issue.

11. The non-transitory machine-readable medium of claim 10, wherein estimating the cognitive load comprises:
calculating a first metric based on a level of complexity for resolving the customer-encountered issue;
calculating a second metric based on a level of difficulty in processing information regarding the customer-encountered issue;
calculating a third metric based on a ratio of available information related to the customer-encountered issue to available information usable to resolve the customer-encountered issue; and
calculating a numerical score based on the first metric, the second metric, and the third metric, the numerical score representing the estimate of the cognitive load.

12. The non-transitory machine-readable medium of claim 11, wherein the numerical score is calculated using a weight sum of the first metric, the second metric, and the third metric.

13. The non-transitory machine-readable medium of claim 11, wherein calculating the first metric comprises:
making a first determination regarding whether the customer-encountered issue is a known issue; and
in a first instance of the first determination where the customer-encountered issue is known, retaining the first metric at a current score.

14. The non-transitory machine-readable medium of claim 13, wherein calculating the first metric further comprises:
in a second instance of the determination where the customer-encountered issue is not known:
making a second determination regarding whether a run book for a class of the customer-encountered issue is available;
in a first instance of the second determination where the run book for the class of the customer-encountered issue is available, increasing the current score of the first metric by a first amount;
in a second instance of the determination where no run book for the class of the customer-encountered issue is available, increasing the current score of the first metric by a second amount, the second amount being larger than the first amount.

15. The non-transitory machine-readable medium of claim 11, wherein calculating the second metric comprises:
identifying available support data for the customer-encountered issue;
making a first determination regarding whether the available support data is complete;
in a first instance of the first determination where the available support data is complete, retaining the second metric at a current score;
in a second instance of the first determination where the available support data is incomplete, increasing the current score of the second metric.

16. The non-transitory machine-readable medium of claim 15, wherein increasing the current score of the second metric comprises:
enumerating the support data based on a schema that defines expected portions of data for the support data to be complete;
calculating a numerical value based on a number of elements of the schema that are not present in the enumerated support data; and
adding a value to the current score based on the numerical value.

17. The non-transitory machine-readable medium of claim 10, wherein the estimate of the cognitive load is based on an inherent cognitive load, an extraneous cognitive load, and a germane cognitive load.

18. The non-transitory machine-readable medium of claim 17, wherein the estimate of the cognitive load falls within a range of available service agent levels.

19. A data processing system, comprising:
a processor; and
a memory coupled to the processor to store instructions, which when executed by the processor, cause the processor to perform operations for managing customer-encountered issues using service agents, the operations comprising:
estimating a cognitive load to resolve a customer-encountered issue of the customer-encountered issues;
selecting a service agent level based on the cognitive load;
selecting a service agent of the service agents, the selected service agent having the selected service agent level; and
resolving the customer-encountered issue by assigning the selected service agent to work the customer-encountered issue.

20. The data processing system of claim 19, wherein estimating the cognitive load comprises:
calculating a first metric based on a level of complexity for resolving the customer-encountered issue;
calculating a second metric based on a level of difficulty in processing information regarding the customer-encountered issue;
calculating a third metric based on a ratio of available information related to the customer-encountered issue to available information usable to resolve the customer-encountered issue; and
calculating a numerical score based on the first metric, the second metric, and the third metric, the numerical score representing the estimate of the cognitive load.
